(19) United States
(12) Patent Application Publication
(10) Pub. No.: US 2024/0025069 A1
(43) Pub. Date: Jan. 25, 2024

(54) COMPLIANT ROLLER CUTTER

(71) Applicant: The Curators of the University of Missouri, Columbia, MO (US)

(72) Inventors: Ashok Midha, Rolla, MO (US); Pratheek Bagivalu Prasanna, Rolla, MO (US); Vamsi Lodagala, Rolla, MO (US); Sushrut G. Bapat, Berkeley, CA (US); Prem Midha, St. Paul, MN (US)

(21) Appl. No.: 18/355,971

(22) Filed: Jul. 20, 2023

Related U.S. Application Data
(60) Provisional application No. 63/391,234, filed on Jul. 21, 2022.

(51) Int. Cl. B26B 25/00

(52) U.S. Cl. CPC B26B 25/005; B26B 25/002

(57) ABSTRACT

A roller cutter for cutting a material includes a rotatable roller, a rotatable blade, and a rotation transmission mechanism. The roller includes an outer rim configured to engage the material at a roller engagement point. The blade includes a cutting edge configured to cut the material at a blade engagement point. The blade engagement point is spaced from the roller engagement point. The rotation transmission mechanism is configured to drivingly interconnect the blade and the roller such that the blade rotates faster than the roller. The roller cutter is configured such that the cutting edge applies both a compressive shear force and a tangential shear force to the material at the blade engagement point as the blade is pressed into the material and the blade and the roller rotate.

### CROSS-REFERENCE TO RELATED APPLICATION

### 1. Priority Application

The present application claims the benefit of and priority from U.S. Provisional Patent Application No. 63/391,234, filed Jul. 21, 2022, the entire disclosure of which is hereby incorporated by reference herein.

### BACKGROUND OF THE INVENTION

### 1. Field of the Invention

The present invention relates generally to roller cutters, also commonly known as rotary cutters, for cutting one or more layers of material.

### 2. Discussion of the Prior Art

Conventional roller cutters include a disk-like blade rotatable about a blade axis and having a circumferentially extending cutting edge at an outer margin thereof. Cutting of one or more layers of material occurs as the cutting edge is pressed into a surface of the material. More particularly, cutting occurs when a compressive force is applied by the blade on the surface of the material to be cut, and the resulting normal shear force facilitates insertion of the cutting edge into the material. The location at which the compressive force is applied (and at which a resulting normal shear force is generated) varies as the blade rolls forward or backward relative to the material surface.

Often, a user may manually apply tension to the material or otherwise hold or manipulate the material in order to facilitate more efficient cutting, with bunching and other forms of material collapse reducing cutting effectiveness if not adequately addressed.

### SUMMARY

According to one aspect of the present invention, a roller cutter is provided for cutting a material. The cutter comprises a rotatable roller, a rotatable blade, and a rotation transmission mechanism. The roller includes an outer rim configured to engage the material at a roller engagement point. The blade includes a cutting edge configured to cut the material at a blade engagement point. The blade engagement point is spaced from the roller engagement point. The rotation transmission mechanism is configured to drivingly interconnect the blade and the roller such that the blade rotates faster than the roller. The roller cutter is configured such that the cutting edge applies both a compressive shear force and a tangential shear force to the material at the blade engagement point as the blade is pressed into the material and the blade and the roller rotate.

This summary is provided to introduce a selection of concepts in a simplified form. These concepts are further described below in the detailed description of the preferred embodiments. This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWING FIGURES

Preferred embodiments of the present invention are described in detail below with reference to the attached drawing figures, wherein:

FIG. 1 is a front perspective view of a roller cutter in accordance with a preferred embodiment of the present invention;

FIG. 2 is a rear perspective view of the roller cutter of FIG. 1;

FIG. 3 is an exploded front perspective view of the roller cutter of FIGS. 1 and 2;

FIG. 4 is an exploded rear perspective view of the roller cutter of FIGS. 1-3;

FIG. 5 is an enlarged bottom perspective view of the roller cutter of FIGS. 1-4;

FIG. 6 is an enlarged, partially sectioned rear perspective view of the roller cutter of FIGS. 1-5;

FIG. 7 is an enlarged rear perspective view of the roller cutter of FIGS. 1-6, with selected elements shown in hidden line to better illustrate the functionality of the guide element and the disc spring;

FIG. 8 is an enlarged, partially exploded front perspective view of the roller cutter of FIGS. 1-7, particularly illustrating the arrangement of the pinion gear, the ring gear, and the compliant mechanism;

FIG. 9 is an enlarged, cross-sectional side view of the roller cutter of FIGS. 1-8 with the nut in an outer position relative to the bolt and the disc spring consequently only slightly compressed;

FIG. 10 is a cross-sectional side view similar to that of FIG. 9, but with the nut in an inner or tightened position relative to the bolt and with the disc spring significantly compressed and the roller engaging the handle as a result;

FIG. 11 is an enlarged, simplified rear view of a portion of the roller cutter of FIGS. 1-10, with selected components shown in hidden line for clarity, particularly illustrating initial contact of the outer rim of the roller with the surface of the material to be cut and a general orientation of the guide element;

FIG. 12 is a rear view of a portion of the roller cutter similar to that of FIG. 11, but particularly illustrating contact between both the roller and the blade with the material surface, with the roller contact point being disposed forward of the blade contact point, and with the guide element in the guidance position;

FIG. 13 is a front perspective view of the roller cutter of FIGS. 1-12, but with a safety cover installed over the blade;

FIG. 14 is a partially exploded front perspective view of the roller cutter as shown in FIG. 13; and

FIG. 15 is a rear perspective view of the safety cover of FIGS. 13 and 14.

The drawing figures do not limit the present invention to the specific embodiments disclosed and described herein. While the drawings do not necessarily provide exact dimensions or tolerances for the illustrated structures or components, the drawings are to scale with respect to the relationships between the components of the structures illustrated in the drawings.

### DETAILED DESCRIPTION

The present invention is susceptible of embodiment in many different forms. While the drawings illustrate, and the specification describes, certain preferred embodiments of the invention, it is to be understood that such disclosure is by way of example only. There is no intent to limit the principles of the present invention to the embodiments.

Furthermore, unless specified or made clear, the directional references made herein with regard to the present invention and/or associated components (e.g., top, bottom, upper, lower, inner, outer, etc.) are used solely for the sake of convenience and should be understood only in relation to each other. For instance, a component might in practice be oriented such that faces referred to as “top” and “bottom” are sideways, angled, inverted, etc. relative to the chosen frame of reference.

### Overview

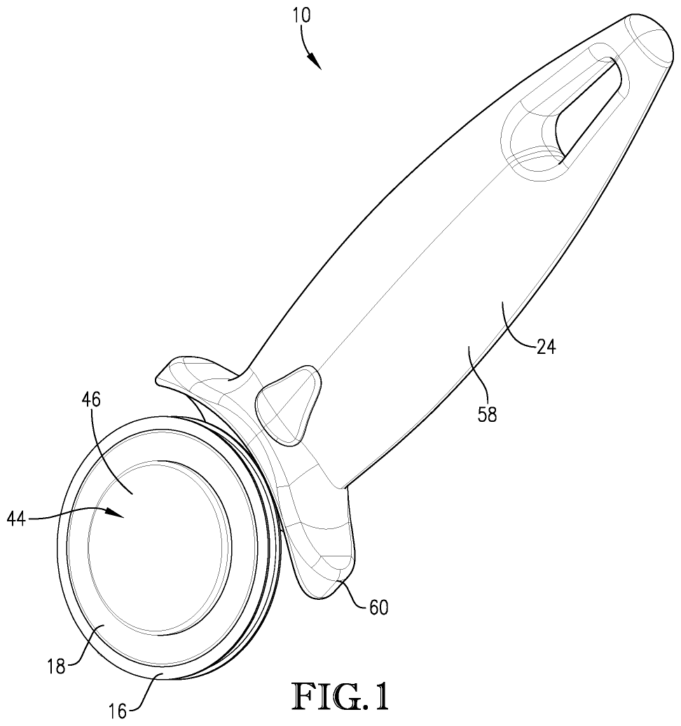

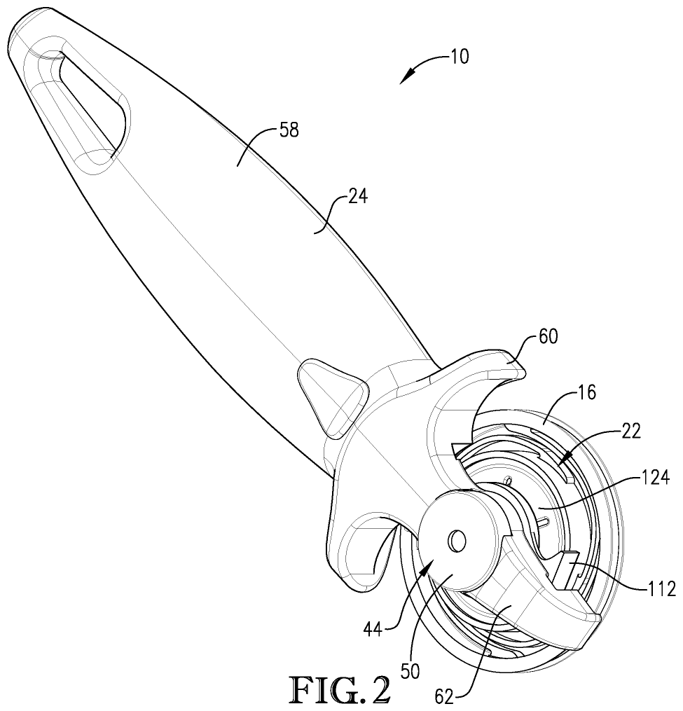

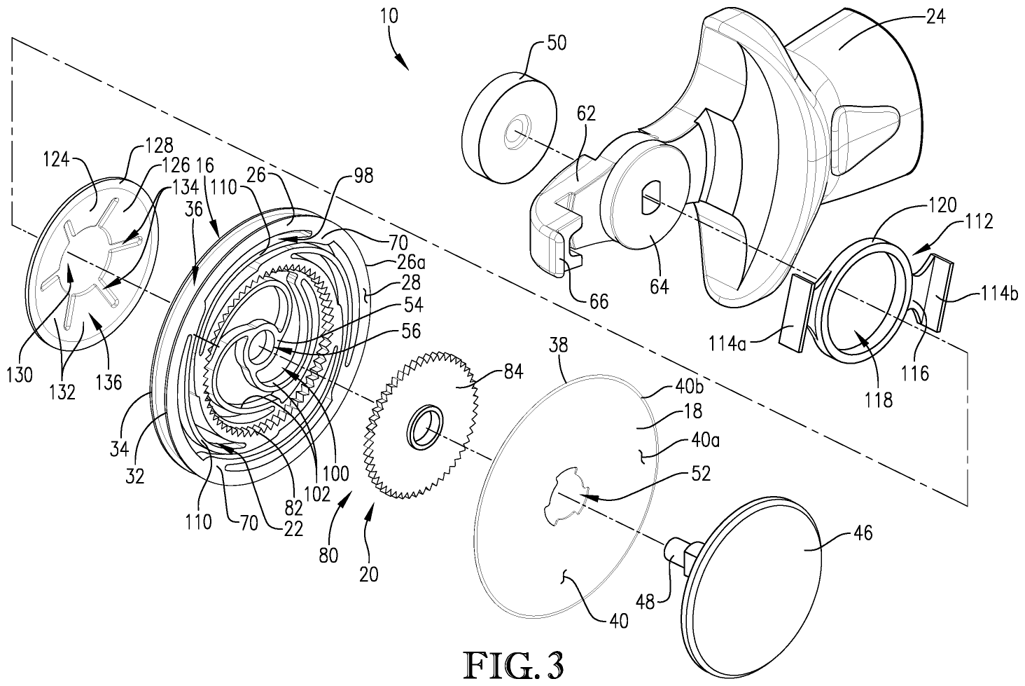

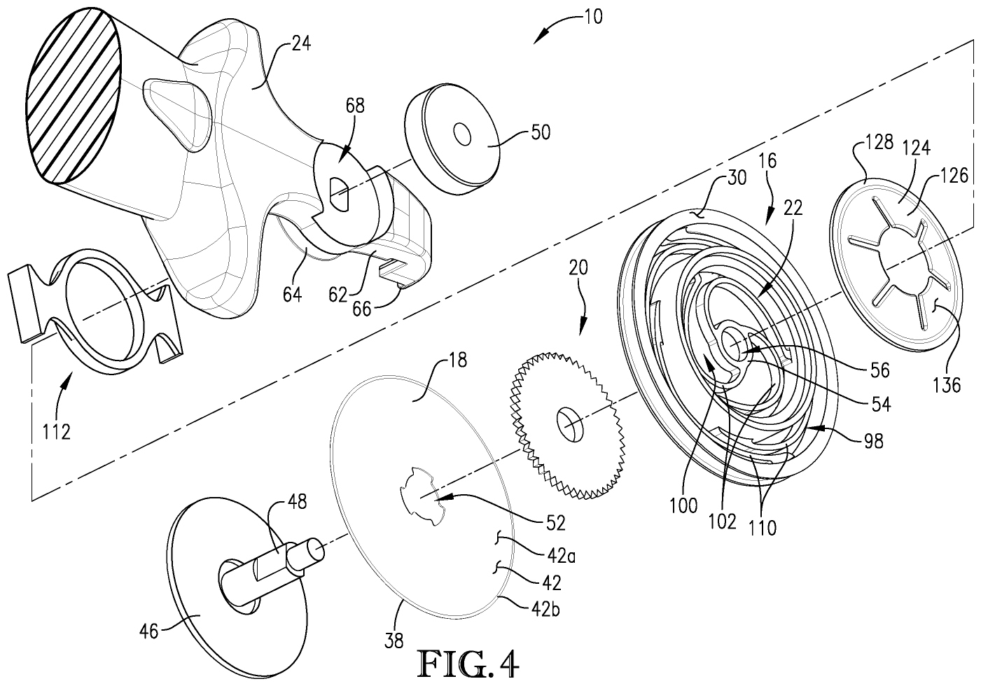

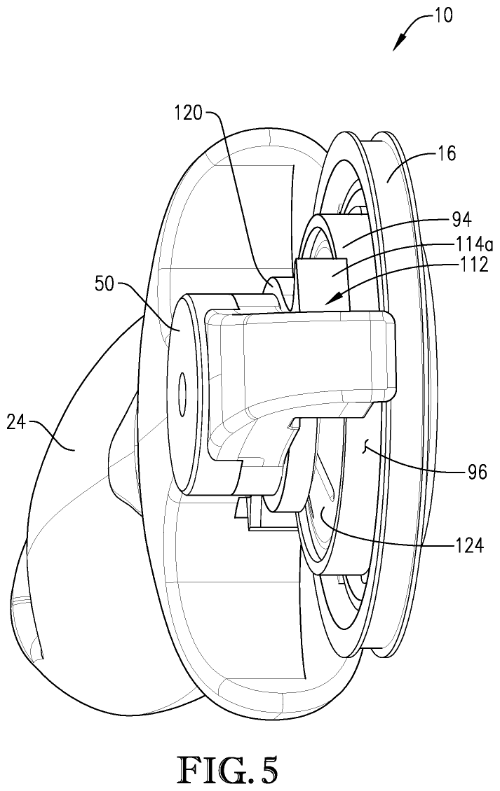

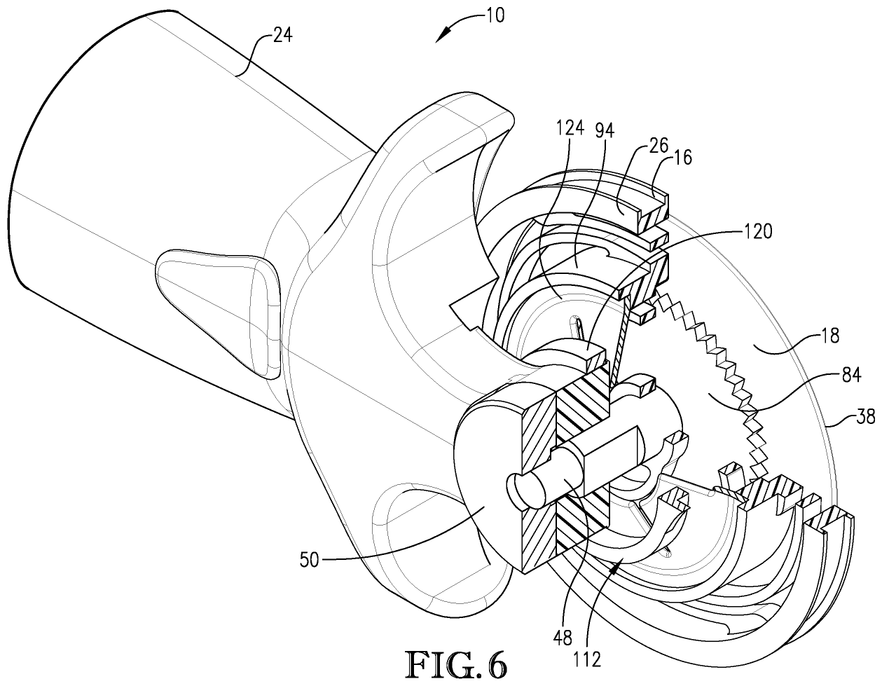

Turning now to FIGS. 1 and 2, a roller cutter 10 (which may alternatively be referred to as a rotary cutter or a roller or rotary trimmer) is illustrated. As will be discussed in detail below, the roller cutter 10 is configured to cut a material 12. More particularly, the roller cutter 10 engages and cuts through a surface 14 of the material 12 upon traversal of the material 12 in a cutting direction D that is generally parallel to the relevant portion of the surface 14. The cutting direction D will be discussed in greater detail below.

In a broad sense, the roller cutter 10 includes a rotatable roller 16, a rotatable blade 18, a rotation transmission mechanism 20, a compliant mechanism 22, and a handle 24.

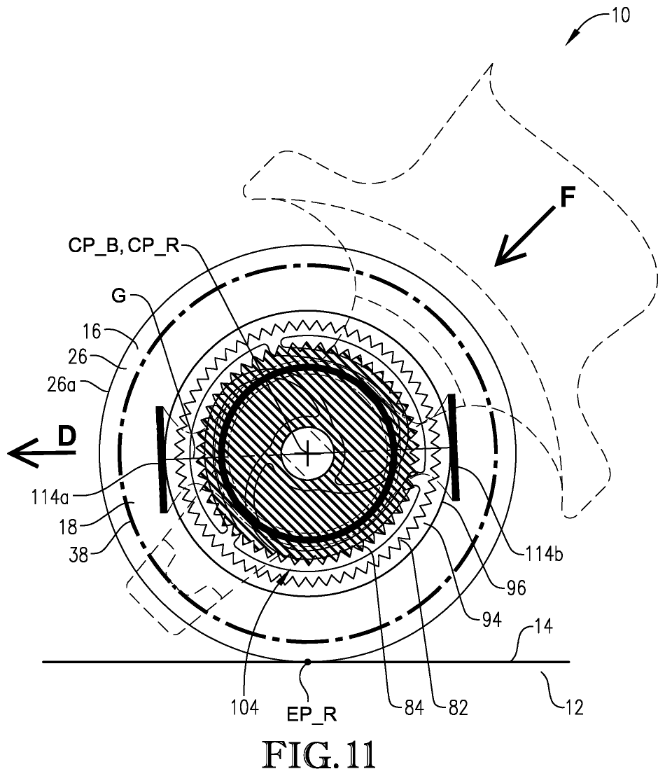

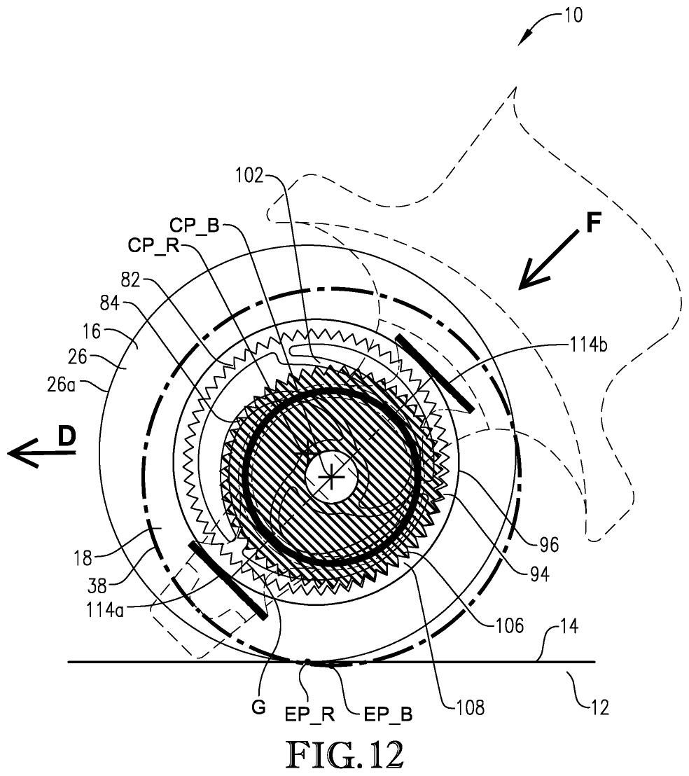

The roller 16 includes an outer rim 26 configured to engage the material at a roller contact or engagement point EP_R (FIGS. 11 and 12). The outer rim 26 preferably extends perimetrically about the roller 16. Furthermore, the outer rim 26 preferably extends continuously, although discontinuities fall within the scope of some aspects of the present invention.

The rim 26 preferably presents a front face 28 and a back face 30 opposite the front face 28.

The rim 26 preferably includes arcuately extending front and back ridges 32 and 34 defining a groove 36 therebetween. The front ridge 32 furthermore preferably in part defines the front face 28. The back ridge 34 similarly preferably in part defines the back face 30.

A gripping element (not shown) may be in part inserted into or formed within the groove 36 and in some embodiments may extend into overlying engagement with the apexes of the ridges 32 and 34. It is permissible according to some aspects of the invention for the groove to be unfilled, however.

The gripping element, if included, is preferably in the form of an elastic material such as a thermoplastic elastomer (TPE), although other materials fall within the scope of some aspects of the present invention. The gripping element preferably aids in even distribution of forces from the rim 26 to the material 12. The gripping element also preferably resists slipping (as opposed to rolling) of the rim 26 relative to the material 12.

Resistance to rolling or rotation of the material 12 to be cut is also provided as a result of the dual-ridge design of the roller rim 26. More particularly, the two (2) distinct contact points provided by the apexes of the ridges 32 and 34 provide two (2) reaction points through which forces are transmitted to hold and keep the material 12 from turning. The slicing action of the blade 18 is thus preserved.

Although two (2) ridges are preferred, is noted that rims including additional ridges or being devoid of ridges are also permissible according to some aspects of the present invention.

The rotatable blade 18 preferably includes a cutting edge 38 configured to engage and cut the material 12 at a blade contact or engagement point EP_B (FIG. 12). The cutting edge 38 preferably extends perimetrically about the blade 18. Furthermore, the cutting edge 38 preferably extends continuously, although discontinuities fall within the scope of some aspects of the present invention. Smooth extension (e.g., without bumps, ridges, or other irregularities) is also most preferred.

The blade 18 preferably presents a front face 40 and a back face 42 opposite the front face 40. The front face 40 preferably includes respective main and edge portions 40a and The back face 42 preferably includes respective main and edge portions 42a and 42b. The main portions 40a and 42a are preferably at least substantially parallel to one another. The edge portions 40b and 42b, in contrast, preferably angle toward one another to form a V-shape having an apex that defines the cutting edge 38. In a preferred embodiment, the cutting edge 38 presents a symmetrical V-shaped profile, although asymmetry is permissible in some embodiments. Furthermore, alternative edge formation geometries in a broad sense also fall within the scope of some aspects of the present invention.

Preferably, both the outer rim 26 of the roller 16 and the cutting edge 38 of the blade 18 extend along a circular path so as to be circumferentially extending. That is, the roller 16 and the blade 18 are both preferably disc-like or circular in shape. Shape variations, whether in an overall sense (e.g., an oval form in general) or along the rim or cutting edge itself (e.g., serrated, scalloped, etc.) are also permissible according to some aspects of the present invention, however.

As will be discussed in greater detail below, the rotation transmission mechanism is configured to drivingly interconnect the blade 18 and the roller 16 such that the blade 18 rotates faster than the roller 16. Alternatively stated, the rotation transmission mechanism 20 interconnects the roller 16 and the blade 18 such that the roller 16 and the blade 18 are configured to rotate contemporaneously (i.e., to both rotate at the same time), but with the blade 18 rotating faster than the roller 16.

It is noted that the lateral movement of the roller cutter 10 relative to the material 12 is preferably in a cutting direction D that is generally parallel to a surface 14 of the material between the roller and blade engagement points EP_R and EP B, respectively. Furthermore, it is noted that the direction D may be either “forward” or “backward” in a conventional sense, with the roller engagement point EP_R “leading” the blade engagement contact point EP_B regardless of whether the roller cutter 10 as a whole is being pushed away from a user (i.e., moving “forward”) or being pulled toward a user (i.e., moving “backward”).

Still further, the cutting direction D is preferably at least substantially defined within a plane extending along or parallel the blade 18 or, more specifically, the cutting edge 38 thereof. That is, the blade 18 is preferably aligned with and readily rollable in the cutting direction, and the blade 18 and the cutting direction are co-planar.

The blade 18 itself is preferably rotationally symmetrical, although variations fall within the scope of some aspects of the present invention.

The blade 18 preferably comprises steel (e.g., stainless steel, carbon steel, Tungsten steel, etc.) or another material suitable for cutting, including but not limited to certain ceramics. It is noted that appropriate materials will vary with the intended cutting application, with less robust blade materials sufficient for cutting of less challenging materials (e.g., single layers of woven cotton fabric) and higher quality blade materials necessary for cutting of more challenging materials (e.g., leather).

Coating of part or all of the blade is also permissible according to some aspects of the present invention. For instance, the edge of the blade might be coated with diamond on either or both sides to facilitate use in cutting or scribing of challenging materials.

The blade 18 and the roller 16 are preferably rotatably secured to the handle 24 by an axle assembly 44. The axle assembly 44 preferably includes an axle head 46, an axle 48 extending axially from the axle head 46, and a nut 50 disposed on the axle 48 and spaced from the axle head 46. The axle 48 preferably defines an axis of rotation of the blade 18 and extends orthogonally relative to the body of the blade 18. Furthermore, the blade 18 defines a central blade center point CP_B that lies on the blade axis of rotation. Alternatively stated, the cutting edge 38 extends arcuately (in this instance, circumferentially) about the blade center point CP_B.

More particularly, the blade 18 preferably defines a central blade axle opening 52 in alignment with the blade center point CP_B. The roller 16 includes a roller hub 54 defining a roller axle opening 56. The roller 16 and the blade 18 are disposed axially between the axle head 46 and the nut 50, with the axle 48 extending through the blade axle opening 52 and the roller axle opening 56.

It is noted that the rim 26 of the roller 16 preferably extends arcuately and, in the present embodiment, circumferentially, about a rim center point CP_R. As will be discussed in greater detail below, when the roller 16 is in a non-deformed state, the rim center point CP R and the blade center point CP_B are in axial alignment with one another. Thus, the rim 26 of the roller 16, the hub 64 of the roller 16, and the edge 38 of the blade 18 are all at least substantially concentric with one another; the axis of rotation of the blade 18 is coextensive with an axis of rotation of the roller 16; and the blade and rim center points CP_B and CP_R are co-located.

The handle 24 preferably includes a grip portion 58, a guard 60, a support strut 62, a hub 64 disposed on the support strut 62, and an outer lip 66 at an end of the strut 62.

Most preferably, the nut 50 is threadably received on the axle 48 (threads not shown) in a nut recess or seat 68 defined by the strut 62 of the handle 24. The seat 68 is preferably defined in axial alignment with the hub 64, although offset configurations fall within the scope of some aspects of the present invention.

As will be readily apparent to those of ordinary skill in the art, the handle 24, as well as the roller 16 and the blade 18, is thus at least in part disposed axially between the axle head 46 and the nut 50.

As will be discussed in greater detail below, the nut 50 is axially shiftable along the axle 48 so as to increase or decrease axial compressive forces on selected components of the cutter That is, the axle assembly 44 may be adjusted to “loosen,” “tighten,” or even “lock” the roller cutter 10 in a broad sense.

In a preferred embodiment, for instance, the range of motion of the nut 50 along the axle 48 is such that the blade 18 and the roller 16 may rotate substantially freely when the nut is in a distal position along the axle 48 (i.e., farther from the head 46). Alternatively, the blade 18 and the roller 16 may be forcefully compressed against one another and/or the handle 24 to the extent that, absent significant overcoming forces, rotation is severely restricted or eliminated when the nut 50 is in a proximal position along the axle 48 (i.e., nearer to the head 46). In the latter instance, the nut 50 functions as part of a safety device, essentially “locking” the blade 18 in position and preventing or at least significantly reducing the likelihood of inadvertent cutting of persons or materials. Again, this functionality will be discussed in greater detail below.

Alternate mounting means of the blade and/or roller fall within the scope of some aspects of the present invention, although it is essential that rotation of both the blade and the roller be facilitated.

The roller 16 preferably includes a plurality of arcuately spaced apart bearing tabs 70 providing bearing support for the blade 18. Such tabs may be omitted without departing from the scope of some aspects of the present invention, however.

The handle 24 is preferably ergonomically designed for user comfort and control. Furthermore, the handle 24 is preferably designed for use with either left or right hands. It is permissible according to some aspects of the present invention, however, for the handle to be sized and/or shaped for specific users or user subsets. For instance, the handle might be designed for with a specific hand orientation or size. The handle may also be designed for use as part of a machine, completely eliminated, or provided in an entirely alternative form. For instance, whereas the present handle 24 is designed to be gripped by a user's palm and fingers in such a manner that the fingers wrap around the handle, the handle could instead be in the form of a half-round casing meant to fit in the palm of a user's hand. (Thus, rather than extending generally parallel to the user's forearm, the alternative handle would be disposed beneath and overlaid by the hand.)

Although the roller cutter 10 may be associated in some manner with a motorized mechanism, it is noted that, in a preferred embodiment, rotation of the blade 18 is not directly motorized. That is, the rotation and associated tangential shearing motion of the blade 18, as described in detail below, is most preferably generated by the rolling motion of the roller 16 as transferred to the blade 18 via the transmission mechanism 20. This is in contrast, for instance, to a cutter in which rotation of the blade is driven through powered rotation, whether directly or via a transmission, and disassociated from the roller.

Furthermore, although it is preferred that the lateral motion of the roller 16 in the cutting direction D (which corresponds to rotation or rolling of the roller 16) is manually driven, it is permissible according to some aspects of the present invention for such motion to be machine-controlled. In such an embodiment, however, it is noted that the transmission mechanism 20 would preferably still be operational as illustrated and as described herein to drive rotation of the blade 18 itself. That is, mechanization of the lateral motion of the roller or even of the rotation of the roller itself does not inherently affect the operation of other aspects of the roller cutter 10.

Finally, it is noted that certain aspects of the present invention may be nevertheless be applicable to roller cutters in which rotation of the blade itself is at least in part driven non-manually (e.g., through a motor) and/or without association with the roller and transmission.

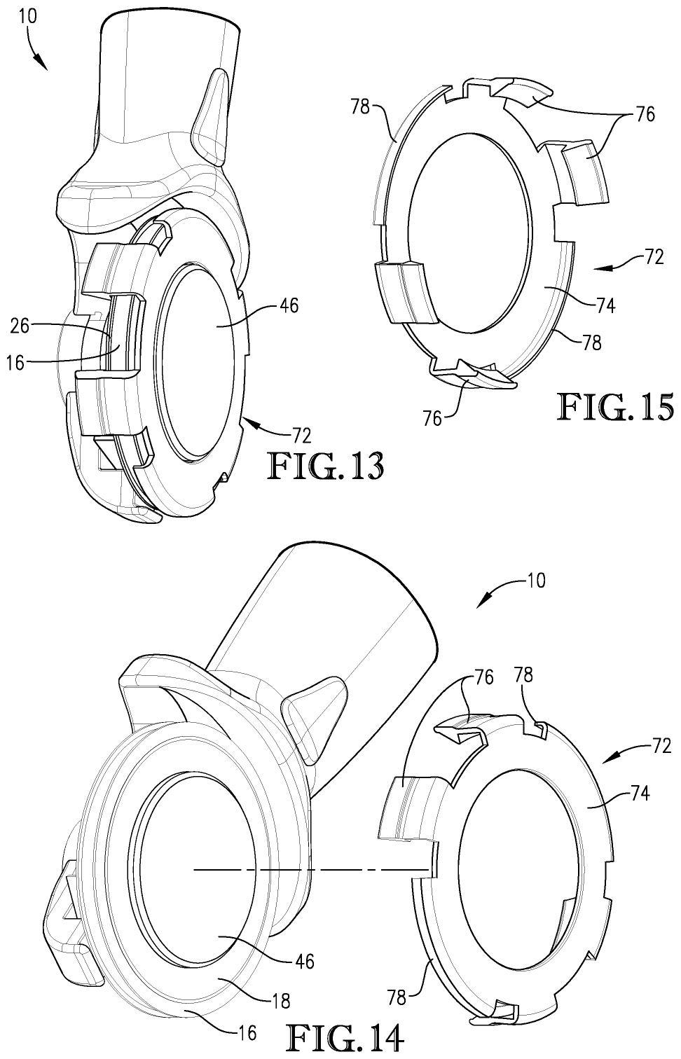

A safety cover 72 may also be provided, although omission of such falls within the scope of some aspects of the present invention. In the illustrated embodiment, the safety cover 72 (FIGS. 13-15) includes a toroidal body 74, a plurality of arcuately spaced apart, resiliently deformable latches 76 extending generally orthogonally from the body 74, and a pair of diametrically opposed lips 78 also extending generally orthogonally from the body 74. When the cover 72 is installed, the body 74 extends around the axle head 46 in overlying engagement with a portion of the front face 40 the blade 18 and covering the cutting edge 38 thereof. The lips 78 extend axially and arcuately along the rim 26 of the roller 16, and the latches 76 likewise extend axially and arcuately along the rim 26 but also engage the back face 30 thereof. Radially outward deflection of the latches 76 must therefore occur to enable subsequent removal of the safety cover 72.

### Transmission Mechanism

The transmission mechanism 20 preferably comprises a gear mechanism 80 that selectively drivingly interconnects the blade 18 and the roller 16. More particularly, in a preferred embodiment, the gear mechanism 80 includes an outer ring gear 82 fixed relative to the roller 16 to rotate therewith, and an internal pinion gear 84 fixed relative to the blade 18 to rotate therewith.

The ring gear 82 includes an inner toothed region 86 including a plurality of radially inwardly extending ring gear teeth 86a. The pinion gear 84 includes an outer toothed region 88 including a plurality of radially outwardly extending pinion gear teeth 88a that intermesh with corresponding ones of the radially inwardly extending ring gear teeth 86a.

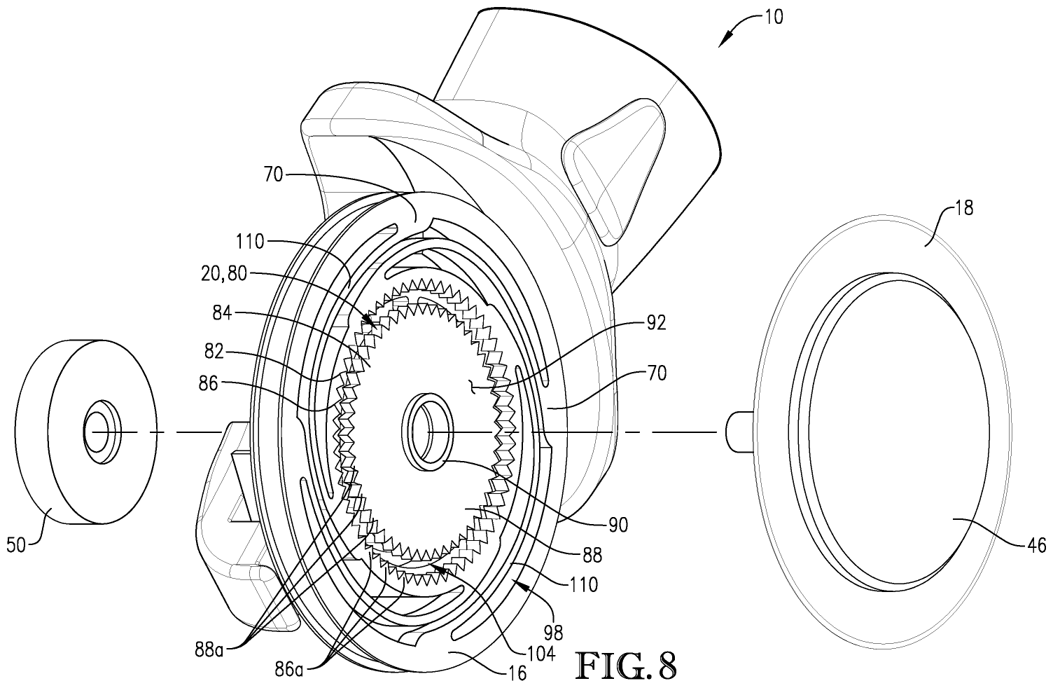

The pinion gear 84 presents an outer diameter that is smaller than the inner diameter defined by the ring gear 82. More particularly, in a resting state of the roller cutter 10 (see, for instance, FIGS. 8 and 11), the teeth 86a and 88a do not engage one another. When the gears 82 and 84 are drivingly interengaged, however, in a process described in greater detail below, relative rotation occurs between the ring gear 82 and the pinion gear 84 as the toothed regions 86 and 88 (or, more specifically, selected ones of the teeth 86a and 88a) intermesh (See FIG. 12) and the pinion and ring gears 82 and 84 rotate. Furthermore, the pinion gear 84 rotates with a higher angular velocity than the ring gear 82. In turn, the blade 18 rotates faster than the roller 16.

In a preferred embodiment, the roller 16 rotates at a roller speed that is between about fifty percent (50%) and about ninety-five percent (95%) of the blade speed. More preferably, the roller speed is between about seventy percent (70%) and about ninety percent (90%) of the blade speed. Most preferably, the roller speed is about eighty percent (80%) of the blade speed.

It is noted that, although the pinion gear 84 and the ring gear 82 are preferably coaxial in a resting state of the roller cutter 10, the axes are offset but parallel during engagement of the gears 82 and 84. This will be discussed in greater detail below. Alternatively stated, the centers of the pinion gear 84 and the ring gear 82 are offset during engagement of the gears 82 and 84.

Although it is preferred that the ring gear 82 be fixed relative to the roller 16 and the pinion gear 84 be fixed relative to the blade 18, it is permissible according to some aspects of the present invention for a reversed configuration to be utilized, with the ring gear fixed relative to the blade and the pinion gear fixed relative to the roller.

It is also permissible according to some aspects of the present invention for the transmission mechanism to be alternatively configured (e.g., to include a sun gear and one or more planet gears, to include additional gears engaging the ring gear, and/or to be entirely alternatively arranged). Preferably, however, any such modifications will still maintain the preferred faster rotation speed of the blade compared to the roller. Furthermore, although rigid systems may fall within the scope of some aspects of the present invention, it is most preferred that any alternative transmission mechanism designs facilitate the compliance of the roller 16 as discussed in greater detail below.

The pinion gear 84 is preferably discrete from but fixed directly to the blade 18. Such fixation may be via any of a variety of means known in the art, including but not limited to a mechanical bond, a chemical bond as facilitated by glues or other adhesives, a combination of mechanical and chemical/adhesive bonds, and so on. For instance, the pinion gear might be overmolded onto (or molded over) the blade to provide a mechanical bond therebetween, or adhesives might be applied between the back face of the blade and a front face of the pinion gear to provide securement. As shown in the illustrated embodiment, the pinion gear 84 may additionally (or perhaps alternatively) include a forwardly projecting lip 90 that extends through the blade axle opening 52 in a tight fit to also provide securement. Integral formation or indirect fixation of the pinion gear falls within the scope of some aspects of the present invention, however, although configurations enabling ease of replacement of worn blades are most preferred in some instances.

In contrast, it is most preferred that the ring gear 82 be integrally defined by the roller 16. More particularly, in a preferred embodiment, the roller 16 includes an inner rim 94 disposed radially inward from the previously described outer rim 26. The inner rim 94 preferably defines the ring gear 82 on a front and inner side thereof. More particularly, the inner rim 94 preferably includes the radially inner toothed face 86 defining the ring gear 82 and a radially outer guide face 86 opposite the toothed face 86.

Additional functions of the inner rim 94, including those pertaining to the ring gear 82 defined thereby, will be discussed in greater detail below.

Thus, the roller 16 includes the outer rim 26, the roller hub 54, and the inner rim 94 disposed therebetween, with the inner rim 94 defining the ring gear 82. The outer rim 26, inner rim 94 (and ring gear 82), and the roller hub 54 are preferably all integrally formed and interconnected to one another by the compliant mechanism 22.

In greater detail still, and as will be discussed further below, the compliant mechanism 22 preferably includes an external stage 98 that is integrally formed with and extends between and interconnects the outer rim 26 and the inner rim 94, and an internal stage 100 that is integrally formed with and extends between and interconnects the inner rim 94 and the roller hub 54.

It is permissible according to some aspects of the present invention, however, for some or all of the components to be non-integrally formed. For instance, the internal stage of the compliant mechanism could be discrete from either or both of the roller hub and inner rim, but fixed thereto by glues, adhesives, latches, interference elements, etc. Likewise, the external stage of the compliant mechanism could be discrete from either or both of the outer rim and the inner rim, but fixed thereto by glues, adhesives, latches, interference elements, etc.

### Compliant Mechanism

The compliant mechanism 22 is broadly configured to facilitate selective engagement of the pinion gear 84 and the ring gear 82. More particularly, such selective engagement is facilitated by the resiliently deformable nature of the compliant mechanism 22.

As noted previously, the compliant mechanism 22 is preferably integrally formed with the roller 16, with the rim 26 circumscribing the external stage 98, which circumscribes the inner rim 94 (and ring gear 82), which in turn circumscribes the internal stage 100, which in turn circumscribes the inner hub 64. However, discrete formation of one or more of the above components is permissible according to some aspects of the present invention.

Furthermore, although the compliant mechanism 22 and the ring gear 82 are fixed to the roller 16 in some manner (whether integral or otherwise) in a preferred embodiment of the present invention, it is permissible according to some aspects of the invention for the compliant mechanism to instead be formed with or fixed to the blade or in part associated with the blade and in part associated with the roller.

The internal stage 100 of the compliant mechanism 22 preferably includes a plurality of arcuately distributed, arcuately and radially extending resiliently deflectable spokes 102. Each spoke 102 is independently shiftable among neutral and deflected configurations thereof.

In the illustrated embodiment, three (3) spokes 102 are provided, although alternative numbers of spokes are permissible according to some aspects of the present invention.

The internal spokes 102 are preferably generally hook- or J-shaped, with the upper end of the shape engaging the inner ring or rim 94 and the tail end of the shape engaging the inner hub 54. Alternative shapes still offering the desired functionality described below fall within the scope of some aspects of the present invention, however.

The resistance offered by the internal spokes 102 is preferably relatively low in comparison to typical user-applied (or machine- or otherwise-applied) forces to the roller 16 during a cutting process, such that deflection of the internal spokes 102 occurs with ease upon initiation of the cutting process. For instance, deflection of the spokes 102 preferably occurs easily when a user initially presses the roller 16 into or onto the material surface 14 while holding the roller cutter by the handle 24 at the beginning of a cutting process. However, various levels of deflection resistance fall within the scope of some aspects of the present invention.

In a neutral configuration of the spokes 102 (i.e., when each of the spokes 102 is in the neutral configuration thereof), the pinion gear 84 and the ring gear 82 are disengaged from each other (see FIGS. 8, 11, and others). That is, the pinion gear 84 is spaced radially from the ring gear 82, such that a circumferentially extending disengagement gap 104 is present therebetween. Spacing and consequent continued disengagement will also persist upon sufficiently small deflections of one or more internal spokes 102. That is, some deflected configurations of the internal spokes 102 will not lead to engagement between the pinion gear 84 and the ring gear 82.

Upon sufficient deflection of one or more of the internal spokes 102 (or, more generally, the internal stage 100 of the compliant mechanism 22), however, a meshing subset 106 of the outer teeth 88a of the pinion gear 84 mesh with a meshing subset 108 of the inner teeth 86a of the ring gear 82 (see FIG. 12). That is, shifting of at least one of the spokes 102 into a selected one of the deflected configurations thereof facilitates engagement of the pinion gear 84 and the ring gear 82.

Thus, in a practical sense, rotation of the roller 16 resulting from interaction with the surface 14 of the material 12 is drivingly transferred to the blade 18 via interaction of the meshed subsets 106 and 108.

It is also again noted that, by merit of the gear ratio of the pinion gear 84 relative to the ring gear 82, the rotation of the blade 18 is faster than that of the roller 16.

Upon cessation of force application to the roller 16 (e.g., at the end of a cutting process), the internal spokes 102 return to (or very nearly to) their initial, neutral configurations by merit of their aforementioned resiliently deformable natures. It is noted that, although some degree of deformation retention is permissible and to be expected for many suitable materials, such retention is best minimized to retain the functionality of the internal spokes. That is, elastic performance is most optimal.

It is also noted that, when the internal spokes 102 are in their neutral state (and in several of the less-deflected ones of the deflected configurations), the cutting edge 38 in its entirety is disposed radially inward of the outer margin 26a of the rim 26. That is, the cutting edge 38 is protected to some extent by the rim 26, which also acts conversely to protect a user or adjacent materials from the blade 18 when the internal spokes 102 are in their neutral configuration.

When the internal spokes 102 are deflected to the extent that an engaged configuration is initially present, it is most preferred that the blade 18, although now not coaxial with the rim 26, is still not exposed. That is, when gear engagement first occurs (and deformation of the second or external stage 98 of the compliant mechanism 22 has not yet occurred), it is preferred that the radially outer margin 26a of the rim 26 is still disposed radially outward of the cutting edge 38 in its entirety. Equal alignment with the cutting edge 38 (such that substantial cutting is still unlikely to occur) is also permissible according to some aspects of the present invention.

Still further, in some embodiments of the present invention, and in particular in alternative embodiments in which the external stage of the compliant mechanism is omitted, it is permissible for sufficient deflection of the internal stage to result in exposure and cutting capability of the cutting edge.

The external stage 98 of the compliant mechanism 22 is disposed radially outward of the internal stage 100. More particularly, whereas the internal stage 100 extends between and interconnects the inner rim 94 and the internal hub 64, the external stage 98 extends between and interconnects the inner rim 94 and the outer rim 26.

In greater detail still, the external stage 98 includes a plurality of arcuately distributed, arcuately and radially extending resiliently deflectable arms 110 each shiftable among neutral and deflected configurations thereof.

In the illustrated embodiment, four (4) arms 110 are provided, although alternative numbers of arms are permissible according to some aspects of the present invention.

The arms 110 are preferably generally in the shape of relatively low-curvature (i.e., relatively flat) arches, with an outer end of the shape engaging the outer rim 26 of the roller 16 and an inner end of the shape engaging the inner rim 94 of the roller 16. Alternative shapes still offering the desired functionality described below fall within the scope of some aspects of the present invention, however.

In a neutral configuration of the arms 110 (i.e., when each of the arms 110 is in the neutral configuration thereof), the pinion gear 84 and the ring gear 82 may be either disengaged or engaged with one another. In the latter instance, force applied to the roller 16 (e.g., by a user, through the handle 24) has caused sufficient deflection of the spokes 102 of the internal stage of the compliant mechanism 22 to facilitate driving engagement of the gears 82 and 84, but has not (yet) been great enough to cause deflection of the arms 110 of the external stage 98 of the compliant mechanism 22.

As will be apparent from the above, the external stage 98 (or, more specifically, the arms 110) presents a higher stiffness than does the internal stage 100 (including the spokes 102). Thus, a greater force is required to cause their deflection.

Furthermore, any cutting process requires two (2) stages of deflection to occur: the previously described first stage in which the internal stage 100 deflects to facilitate engagement of the gears 82 and 84; and a second stage, described in greater detail below, in which deflection of the external stage 98 facilitates actual cutting of the material 12.

More particularly, as shown in FIG. 12, after deflection of the internal stage 100 results in engagement of the gears 82 and 84, deflection of the external stage 98 results in the inner hub 64, the blade 18, and the pinion gear 84 all shifting toward the material 12 and relative to the outer rim 26 of the roller 16, with the blade 18 preferably contacting the material 12 at the blade engagement point EP_B and slicing through the surface 14 thereof. The rim 26 of the roller 16 remains on the surface of the material 12, engaging it at the roller engagement point EP_R.

Subsequent increased force application results in further shifting of the blade 18 and associated component as the arms 110 deflect even more, with such shifting corresponding to deeper depth of cutting as the blade 18 shifts even more relative to the rim 26 and extends further past the material surface 14.

Upon cessation of force application to the roller 16 (e.g., at the end of a cutting process), the internal spokes 102 and external arms 110 return to (or very nearly to) their initial, neutral configurations by merit of their aforementioned resiliently deformable natures. It is noted that, although some degree of deformation retention is permissible and to be expected for many suitable materials, such retention is best minimized to retain the functionality of the internal spokes.

It will be readily apparent to those of ordinary skill in the art that, because the external or second stage 98 is stiffer than the internal or first stage 100, provision of the external or second stage 98 will in some instances effectively result in a deliberate action being necessary to expose the blade 18 and engage the tool for its intended use. For instance, it would be necessary for a user whose initial manual force application was sufficient only to engage the first or internal stage 100 to deliberately increase the applied force to fully engage the external or second stage 98 and expose the blade 18 for cutting.

Turning again to the initial contact of the blade 18 with the material surface 14, it is noted that the deformation of the compliant mechanism 22 facilitates shifting of the blade 18 both downward and in opposition to the cutting direction D relative to the roller 16 (or shifting of the roller 16 overall both upward and in the cutting direction D relative to the blade 18), where the cutting direction is understood to be generally parallel to the surface 14. (Although the cutting direction D is typically in a “forward” direction away from the user, a “backward” direction is also permissible). This shifting results in the blade 18 engaging the material 12 at the blade engagement point EP_B rearward of (i.e., behind, in the cutting direction D) the roller engagement point EP_R.

In summary, shifting of at least one of the spokes 102 of the internal stage 100 into a selected one of the deflected configurations enables shifting of the pinion gear 84 into engagement with the ring gear 82. Shifting of at least one of the arms 110 of the external stage 98 into a selected one of the deflected configurations enables shifting of the cutting edge 38 of the blade 18 relative to the rim 26 of the roller 16, such that both the rim 26 and the cutting edge 38 engage the material at the roller and blade engagement points EP_R and EP_B, respectively, with the blade engagement point EP_B being spaced rearwardly from the roller engagement point EP_R. Because the external stage 98 has a higher stiffness than the internal stage 100, deformation of the internal stage spokes 102 occurs prior to deformation of the external stage arms 110, such that engagement of the pinion gear 84 and the ring gear 82 is facilitated prior to shifting of the cutting edge 38 into contact with the material 12.

Although resilient deformation of the compliant mechanism 22 is preferably provided by resiliently deflectable spokes 102 and arms 110, as described above, it is noted that other means of providing resilient deformation fall within the scope of some aspects of the present invention. For instance, the spokes and/or the arms could be replaced by or provided in conjunction with one or more flexible or resiliently compressible foams or other materials (e.g., polyurethanes, elastomers, etc.) provided in a generally continuous (i.e., a generally solid or bulk-like) form. A spring-like mesh or other structure could also be provided.

For example, a resiliently compressible ring of material having a first stiffness or resistance to compression could replace all of the inner spokes, and a different resiliently compressible ring of material having a higher stiffness/resistance to compression could replace all of the outer arms. Alternatively, only the arms or only the spokes could be replaced, or spokes and/or arms could be provided in conjunction with material inserts.

Variations in stiffness within a given material insert are also contemplated, both in terms of inherent material composition and in response to varying loads.

In a preferred embodiment of the present invention, the cutting edge 38 of the blade 18 extends around a blade center point CP_B that aligns with the axle 48 and lies on the axis of rotation of the blade 18. The rim 26 of the roller 16 similarly extends about a rim center point CP_R. (Although the rim 26 may deform somewhat from circularity during the cutting process when applied forces are high, an approximate “center” may nevertheless be found.) Prior to deformation of the compliant mechanism 22, the blade and rim center points CP_B and CP_R are aligned with one another along the axis of rotation of the blade 18, as defined by the axle 48. That is, the cutting edge 38 and the rim 26 are both centered about a shared axis. However, by merit of the compliant mechanism, the rim center point CP_R is shiftable relative to the blade center point CP_B and the blade axis of rotation. As shown in FIG. 12, for instance, the rim center point CP_R is offset upward and forward of the blade center point CP_B when the blade 18 engages the material 12 at the blade engagement point EP_B and the rim 26 engages the material 12 at the roller engagement point EP_R. Alternatively stated, the blade center point CP_B shifts downward and rearward relative to the rim center point CP_R upon deformation of either stage 98 or 100 of the compliant mechanism 22.

It is again noted that the spacing of the roller engagement point EP_R ahead of the blade engagement point EP_B in the cutting direction D, as facilitated by the compliant mechanism 22, subjects the material 12 therebetween to tension. The cutting edge 38 thus applies both a compressive shear force and a tangential shear force at the blade engagement point EP_B, leading to more effective cutting of the material 12.

It is also particularly emphasized that this tension is integrally provided by the roller cutter 10 itself. In contrast, a user operating a conventional roller cutter might find it necessary to use one hand to operate the roller and another hand to hold the material to cut under tension. Such cumbersome assistive efforts are made unnecessary by the present design.

### Guide Element

In a preferred embodiment of the present invention, a guide element or degree-of-freedom reducer 112 is provided. The guide element 112 broadly acts to reduce the degrees of freedom of the transmission mechanism 20.

More particularly, as will be readily apparent to those of ordinary skill in the art, the gear mechanism 80, including the ring gear 82 and the pinion gear 84, is an epicyclic gear train having two (2) degrees of freedom: a first associated with regular rotation as driven by interengagement of the teeth 86a and 88a, and a second associated with relative travel or “riding up” of the pinion gear 84 along the ring gear 82 (or, alternatively viewed, the ring gear 82 shifting relative to the pinion gear 84).

As will also be apparent to those of ordinary skill in the art, such “riding up,” if allowed, would result in corresponding “riding up” of the blade 18, which is fixed to the pinion gear 84 to shift therewith. This riding up or lifting would correspond to lifting of the blade 18 away from the surface 14 of the material 12 to be cut, potentially leading to loss of contact and associated cutting errors and/or irregularities, or at least to a change in the depth of cutting if full disconnection does not occur. It is therefore desirable to remove or restrict the gear mechanism degree of freedom that is associated with such riding up. As will be discussed below, the guide element 112 provides a reliable, wear-resistant physical means of such restriction.

The guide element 112 preferably includes a pair of arcuately spaced apart flanges 114a and 114b connected by a crosspiece 116, with the flanges 114a and 114b and the crosspiece 116 cooperating to create a generally H-shaped form. More particularly, the flanges 114a and 114b are preferably diametrically opposed to one another and extend parallel to one another, with the crosspiece 116 extending generally perpendicular to the flanges 114a and 114b.

In addition to connecting the flanges 114a and 114b, the crosspiece 116 preferably defines a hub opening 118 therethrough. More particularly, the crosspiece 116 includes a mounting ring portion 120 that defines the hub opening 118. The hub 64 of the handle 24 of the roller cutter 10 is preferably received in the hub opening 118, with the mounting ring portion 120 circumscribing the hub 64.

The ring portion 120 is preferably sized and shaped to facilitate at least substantially unrestricted or free rotation of the guide element 112 about the hub 64, for purposes which will be described in greater detail below.

Preferably, the hub 64 is provided with a lip 122 that restricts axially forward shifting of the guide element 112 when installed on the hub 64. The strut 62 extends behind the guide element 112 and restricts axially rearward shifting thereof.

The flanges 114a and 114b of the guide element 112 extend axially forwardly from the crosspiece 116. The flanges 114a and 11b also extend tangentially alongside and in part in contact with the outer guide face 96 of the inner rim 94 of the roller 16. That is, the flanges 114a and 114b preferably extend in an axial direction alongside and radially outward of the guide face 96. The flanges 114a and 114b thus act as barriers to in part limit radial shifting of the inner rim 94 relative to the pinion gear 84 (which, as will be apparent from the above, is disposed in fixed concentricity with the guide element 112). As will be discussed in greater detail below, the flanges 114a and 114b further act to restrict relative “riding up” of the pinion gear 84 along the ring gear 82 when the guide element 112 is in a guide position thereof

More particularly, forces applied by a user are generally transmitted through the handle 24 and to the roller 16 and the blade 18 in a force direction F. In the illustrated embodiment, the at least substantially straight extension of the handle 24 is such the handle 24 itself also extends along the force direction F, such that the force direction F may also be understood to be a handle direction. However, it is permissible according to some aspects of the present invention for alternative handle geometries that are at least in part non-aligned with the force direction to be present.

Although the flanges 114a and 114b may be initially oriented in any manner relative to the handle 24 and the force direction F, the rotary cutter 10 is designed such that the guide element 112 self-aligns into a guidance position upon application of a force by the user through the handle 24. The guidance position is such that the guide element 112 mechanically restricts unwanted motion of the pinion gear 84 relative to the ring gear 82 through engagement of the outer face 96 of the guide rim 94. The guidance position and self-alignment process of the guide element 112 are discussed in greater detail below.

It is initially noted that when the guide element 112 is in the guidance position, as illustrated in FIG. 12, the flanges 114a and 114b extend at least substantially perpendicularly to the force direction F (which, in the illustrated embodiment, is also the direction of extension of the handle 24). Alternatively described, the guide element 112 may be understood to have a local guide element axis G extending along the crosspiece 116 and through the flanges 114a and 114b, with the guide element axis G being perpendicular to the flanges 114a and 114b. When the guide element 112 is in the guidance position, the guide element axis G is parallel to or aligned with the force direction F and, in the illustrated embodiment, the extension direction of the handle 24.

In contrast, when the guide element 112 is any of a plurality of general orientations (see, for instance, FIGS. 2, 5, and 11), the guide element axis G is angularly offset from the force direction F and the flanges 114a and 114b are not perpendicular to the force direction.

With reference to FIG. 11, it will be readily understood by those of ordinary skill in the art that initial contact of the roller 16 with the material 12 will be associated with force transmission along the force direction F. Furthermore, as discussed above, increases to such applied force will eventually result first in deformation of the internal stage 100 of the compliant mechanism 22 and consequent engagement of the gears 82 and 84, and thereafter deformation of the external stage 98 of the compliant mechanism and resultant contact of the blade 18 with the material 12 (see FIG. 12).

With continued reference to FIG. 11 and with regard to the guide element 112, however, transmission of force by a user through the handle 24, in the force direction F, will produce a rotational moment on the guide element 112 through its contact with the inner guide rim 94 of the roller 16. That is, a rotational moment acting on the guide element 112 will be generated due to forces from the inner rim 94 against the flanges 114a and 114b. These forces will result in rotation of the guide element 112 until equilibrium is achieved, with the flanges 114a and 114b no longer being “pushed” by the inner rim 94 (i.e., with no moment acting on the guide element 112). This state of equilibrium, illustrated in FIG. 12, corresponds with disposition of the guide element 112 in the previously described guidance position, in which the guide element axis G is aligned with the force direction. Thus, the guide element 112 “self-aligns” through its natural shifting toward equilibrium and, in turn, into the guidance position.

Of course, because the guidance position is dependent on the force direction F, reorientation of the roller cutter 10 and/or a change in the force direction F will result in generation of a new moment applied to the guide element 112 and corresponding rotation of the guide element 112 to re-align itself into the guidance position associated with the new force.

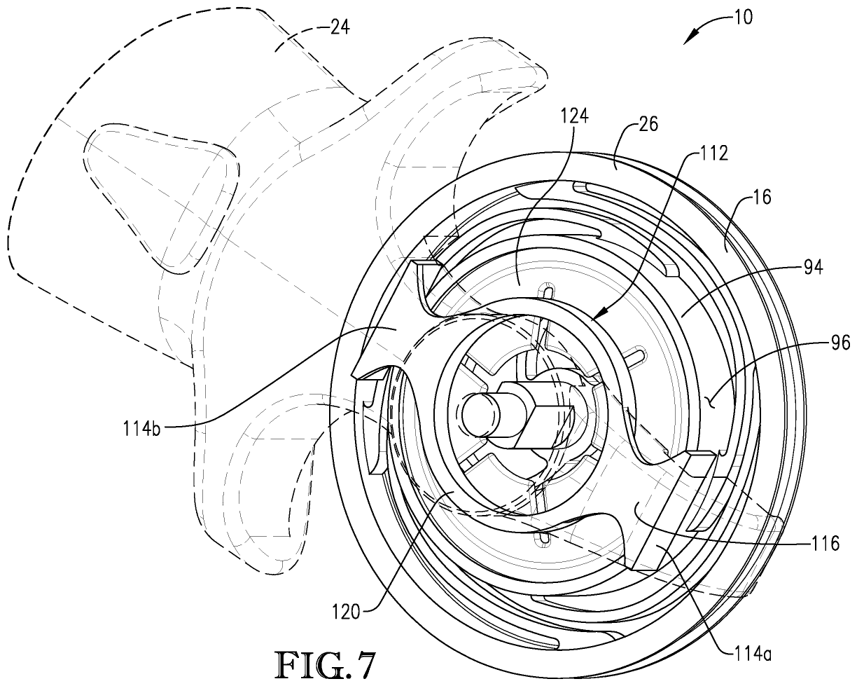

When the guide element 112 is in the guidance position, as shown in FIGS. 7 and 12, the guide element 112 removes the excess freedom in the transmission mechanism 20. More particularly, the guide element 112 removes the degree of freedom in the transmission mechanism 20 associated with “riding up” of the pinion gear 84 relative to the ring gear 82. That is, because the rim 94 is captured between the flanges 114a and 114b, and because the flanges 114a and 114b are fixed radially relative to the pinion gear 84 by merit of their mounting to share an axis of rotation, shifting of the rim 94 and the pinion gear 84 along the handle axis (i.e., in the force direction F) is not permitted. Thus, “riding up” and associate shifting of the cutting edge 38 and potential disconnection thereof from the surface 14 is avoided. Good blade contact is maintained, and skips and other imperfections in the desired cut are avoided.

It is noted that, although provision of a rigid gear train or transmission mechanism could at least to some extent remove the need for a guide element, such a system would fail to provide the advantageous offset blade and roller contact points of the present invention. Furthermore, difficulties with maintaining good blade contact would likely occur.

It is also noted that the guide element 112 as described herein may be readily adapted for use in a variety of other epicyclic or other gear trains having some degree of compliance therein and in which it is desirable to remove a degree of freedom from the system in an efficient, cost-effective, and reliable manner.

### Bearings and Adjustments

As noted previously, the roller cutter 10 includes a nut 50 that is received in the seat 68 defined by the strut 62 of the handle 24. As also noted previously, the nut 50 is axially shiftable along the axle (preferably but not necessarily via threaded engagement) so as to increase or decrease axial compressive forces on selected components of the cutter 10. One such component is a disc spring 124.

The disc spring 124 preferably includes a body 126 and a rim 128 circumscribing the body 126. The body 126 defines a central aperture 130 therethrough. The body 126 includes a plurality of arcuately arranged, radially inwardly extending fingers 132 extending from the rim 128 to the aperture 130. The fingers 132 may alternatively be understood as being formed by radially outwardly extending slits 134 defined in the body 126.

The disc spring 124 presents a front face 136 and a back face 128. The front face 136 is preferably concave in form, whereas the back face 128 is correspondingly convex. A reversed orientation falls within the scope of some aspects of the present invention, however, as do alternative spring designs in a more general sense.

The disc spring 124 is disposed axially behind the ring gear 82 and forward of guide element 112, with the axle 48 extending through the aperture 130. More particularly, the disc spring 124 is seated on a disc spring seat or shelf 140 defined by the inner rim 94 of the roller 16 and makes circumferential contact with a radially inner surface 142 of the inner rim 94.

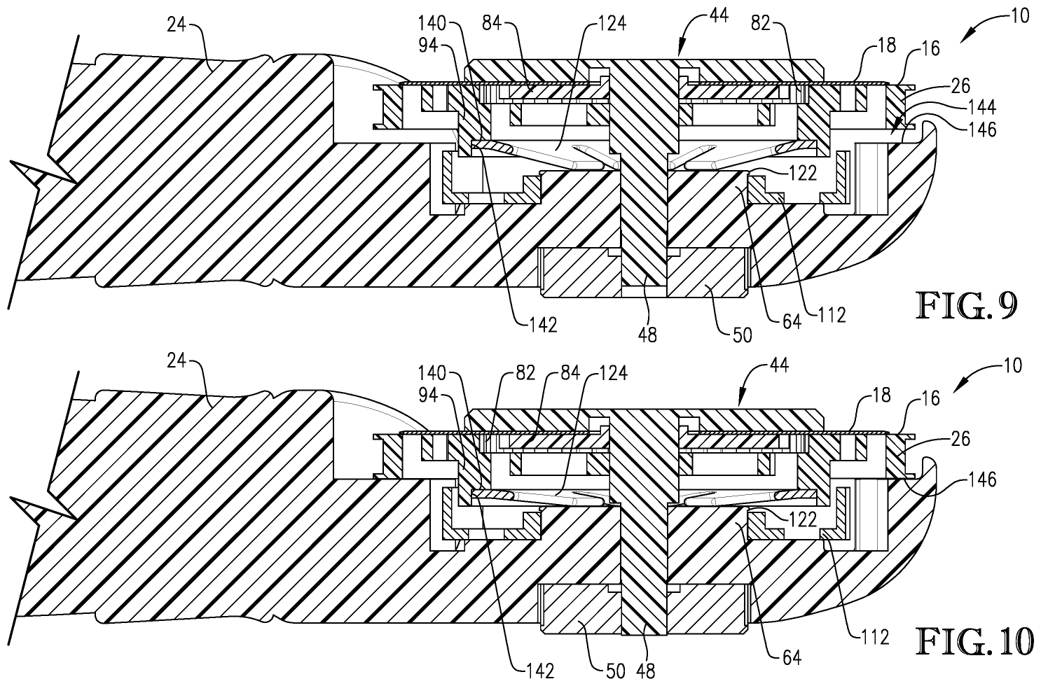

With reference to FIG. 9, when the nut 50 is in an axially rearward position on the axle 48, the disc spring 124 is at least substantially uncompressed, corresponding to a maximum concavity of the front face 136. Contact is made between the rim 128 of the disc spring 124 and both the seat 140 and the inner surface 142 of the guide rim 94. Contact is also made between the backs of the inner ends of the fingers 132 of the disc spring 124 and the front of the hub 64, but such contact is of relatively low force. Furthermore, a circumferentially extending axial gap 144 is present between the rim 26 of the roller 16 and a rim abutment portion 146 of the handle 24.

In contrast, when the nut 50 is tightened into an axially forward position along the axle 48, as shown in FIG. 10, the disc spring 124 is at least substantially compressed (i.e., flattened), corresponding to a decreased concavity of the front face 136 and an increased outward and forward spring force applied by the rim 128 against the inner surface 142 and the seat 140, respectively, of the inner rim 124. That is, contact continues to be made between the disc spring rim 128 and both the inner face 142 and seat 140 of the guide rim 94, and between the back faces of the inner ends of the fingers 132 and the hub 64, but with such contact now being associated with relatively high force due to compression of the spring 124 as the nut 50 draws the hub 64 and the roller 16 toward one another.

In this configuration, shape and rotational stability and distribution of loads is provided to the inner rim 94 of the roller 16 by the disc spring 124. More particularly, forces are spread uniformly from the hub 64 to the fingers 132, from the fingers 132 to the disc spring rim 128, and from the rim 128 of the disc spring 124 to the inner rim 94 of the roller 16.

It is also noted that, as a result of the relative shifting of the hub 64 relative to the roller 16, the previously defined circumferentially extending axial gap 144 between the rim 26 of the roller 16 and the rim abutment portion 146 of the handle 24 is drawn closed, such that contact occurs between the roller 16 and the handle 24. Friction is therefore provided between the roller rim 26 and the abutment portion 146 of the handle 24. This friction, when high enough, may be sufficient to act as a safety feature, preventing unwanted rotation of the blade 18. That is, the nut 50 can be tightened to “lock” the blade 18 when not in use.

Friction that is elevated but not to the point of “locking” the blade may also be beneficial for “heavier” cutting processes by providing resistive feedback to a user that encourages the user to apply more force to the handle and, in turn, to the blade 18 and the roller 16. That is, tightening of the nut 50 prior to cutting of heavy materials or multiple layers may encourage improved cutting by inducing a user to apply an appropriately high force. Such beneficial feedback friction may come at least substantially solely from interaction of the fingers 132 and the hub 64. Alternatively, if the nut 50 has been tightened even further, such feedback friction may come from both the interface of the fingers 132 and the hub 64 and the interface of the rim 26 and the rim abutment portion 146.

A tighter nut 50 and a more compressed disc spring 124 also aid in planarity and stability of the roller cutter 10, helping the various components stay aligned and avoid off-axis motion. Such sturdiness is beneficial in all circumstances but is particularly necessary in heavy cutting situations in which high forces are present that would result in misalignment of a less robust, more flimsy system.

It is noted that, in certain situations in which low cutting forces are applied, the disc spring 124 may be itself sufficient to restrict the excess degree of freedom in the transmission 20 and thus prevent or at least substantially restrict riding up of the pinion gear 84 relative to the ring gear 82. That is, the guide element 112 in these circumstances may not be necessary. However, because the disc spring 124 is subject to and generates friction (e.g., between the fingers 132 and the hub 64) and functions based on its inherent material properties, it is not as reliable or consistent under some circumstances as a mechanical element such as the guide element 112. For instance, the disc spring 124 might wear over time, losing some of its resilience/elasticity and/or its friction-generating ability.

In view of the above, it will be apparent to those of ordinary skill in the art that the disc spring 124 provides bearing support for the roller 16, aids in maintaining planarity of the roller 16 and the roller cutter 10 in general, helps with degree of freedom restriction by restricting the ring gear 82 from riding up relative to the pinion gear 84, and in some instances provides resistive feedback that encourages appropriate force application by a user. The disc spring 124 also helps prevent seizing, with the flexible fingers 132 thereof providing compliance to accommodate imperfections in the hub 64 and other components.

The design of the roller cutter 10 in a broad sense is such that the blade 18 can vary in size without necessarily requiring changes to other components of the roller cutter 10. For instance, increases in the outer diameter of the cutting edge 38 that do not result in the outer diameter of the edge 38 exceeding the outer diameter of the outer rim 26 of the roller 16 do not inherently require changes to any of the existing components of the roller cutter 10.

Similarly, the size of the outer rim 26 of the roller 16 can be modified to some extent without other modifications to the roller cutter 10 necessarily being required.

Of course, it will be readily apparent to those of ordinary skill in the art that some combined modifications could also be made without affecting the functionality of other existing components (e.g., changes to both the outer rim and blade sizes).

### Conclusion

Features of one or more embodiments described above may be used in various combinations with each other and/or may be used independently of one another. For instance, although a single disclosed embodiment may include a preferred combination of features, it is within the scope of certain aspects of the present invention for the embodiment to include only one (1) or less than all of the disclosed features, unless the specification expressly states otherwise or as might be understood by one of ordinary skill in the art. Therefore, embodiments of the present invention are not necessarily limited to the combination(s) of features described above.

The preferred forms of the invention described above are to be used as illustration only and should not be utilized in a limiting sense in interpreting the scope of the present invention. Obvious modifications to the exemplary embodiments, as hereinabove set forth, could be readily made by those skilled in the art without departing from the spirit of the present invention.

Although the above description presents features of preferred embodiments of the present invention, other preferred embodiments may also be created in keeping with the principles of the invention. Furthermore, as noted previously, these other preferred embodiments may in some instances be realized through a combination of features compatible for use together despite having been presented independently as part of separate embodiments in the above description.

The inventors hereby state their intent to rely on the Doctrine of Equivalents to determine and access the reasonably fair scope of the present invention as pertains to any apparatus not materially departing from but outside the literal scope of the invention set forth in the following claims.

What is claimed is:

1. A roller cutter for cutting a material, said cutter comprising:
a rotatable roller including an outer rim configured to engage the material at a roller engagement point;
a rotatable blade including a cutting edge configured to cut the material at a blade engagement point,
said blade engagement point being spaced from said roller engagement point; and
a rotation transmission mechanism configured to drivingly interconnect the blade and the roller such that the blade rotates faster than the roller,
said roller cutter configured such that the cutting edge applies both a compressive shear force and a tangential shear force to the material at the blade engagement point as the blade is pressed into the material and the blade and the roller rotate.

2. The roller cutter of claim 1,
said transmission mechanism comprising a gear mechanism.

3. The roller cutter of claim 2,
said gear mechanism including an outer ring gear fixed relative to one of the roller and the blade to rotate therewith, and an internal pinion gear fixed relative to the other of the roller and the blade to rotate therewith.

4. The roller cutter of claim 3,
said roller integrally defining the ring gear,
said pinion gear being discrete from and fixed to the blade.

5. The roller cutter of claim 3,
said ring gear and said pinion gear being selectively positioned in driving interengagement.

6. The roller cutter of claim 5, further comprising:
a resiliently deformable compliant mechanism facilitating selective engagement of the pinion gear and the ring gear.

7. The roller cutter of claim 6,
said compliant mechanism including a plurality of arcuately distributed, arcuately and radially extending resiliently deflectable spokes each shiftable among neutral and deflected configurations thereof,
said pinion gear and said ring gear being disengaged from each other when each of the spokes is in the neutral configuration thereof,
wherein shifting of at least one of said spokes into a selected one of the deflected configurations thereof facilitates engagement of the pinion gear and the ring gear.

8. The roller cutter of claim 7,
said outer rim presenting a radially outer face,
said cutting edge in its entirety being disposed radially inward of said outer face its entirety when each of the spokes is in the neutral configuration thereof.

9. The roller cutter of claim 7,
said compliant mechanism including an external stage and an internal stage disposed radially inward of the external stage,
said internal stage including the spokes,
said external stage including a plurality of arcuately distributed, arcuately and radially extending resiliently deflectable arms each shiftable among neutral and deflected configurations thereof.

10. The roller cutter of claim 9,
wherein shifting of at least one of said arms into a selected one of the deflected configurations enables shifting of the cutting edge of the blade relative to the rim of the roller, such that both the rim and the cutting edge engage the material at the roller and blade engagement points, respectively.

11. The roller cutter of claim 9,
said external stage having a higher stiffness than said internal stage, such that deformation of the internal stage spokes occurs prior to deformation of the external stage arms, and such that engagement of the pinion gear and the ring gear is facilitated prior to shifting of the cutting edge into contact with the material.

12. The roller cutter of claim 9,
said compliant mechanism and said ring gear being fixed relative to said roller,
said ring gear being disposed radially between said internal and external stages,
said ring gear selectively shifting into and out of engagement with the pinion gear.

13. The roller cutter of claim 6,
said rim, said ring gear, and said compliant mechanism being integrally formed.

14. The roller cutter of claim 5, further comprising:
a guide element including a pair of arcuately spaced apart flanges,
said roller including an inner rim spaced radially inward from the outer rim,
said inner rim including a radially inner toothed face defining the ring gear and a radially outer guide face opposite the toothed face,
said flanges extending axially alongside and radially outward of said guide face to restrict radial shifting of the inner rim relative to the pinion gear.

15. The roller cutter of claim 14, further comprising:
a handle,
each of said roller, said pinion gear, and said guide element being rotatably secured to the handle,
said flanges being diametrically opposed to each other,
said guide element configured to self-align upon engagement of the roller and the blade with the material, with the guide element rotating until the flanges extend at least substantially perpendicular to the handle.

16. The roller cutter of claim 1,
said cutting edge of the blade extending about a blade center point,
said blade being rotatable about a blade axis extending through the blade center point,
said outer rim of the roller extending about a rim center point that is shiftable relative to the blade center point and the blade axis,
said rim center point being offset from the blade center point when the blade engages the material at the blade engagement point and the rim engages the material at the roller engagement point.

17. The roller cutter of claim 1,
said roller cutter configured to traverse the material in a cutting direction generally parallel to a surface of the material,
said roller engagement point being disposed ahead of said blade engagement point in the cutting direction.

18. The roller cutter of claim 1,
said roller rotating at a roller speed,
said blade rotating at a blade speed,
said roller speed being between about 70% and about 90% of the blade speed.

19. The roller cutter of claim 1, further comprising:
a hub,
each of said each of said roller and said pinion gear being rotatably secured to the hub; and
a disc spring disposed between the hub and the roller and transmitting a spring force therebetween to provide bearing support for the roller.

20. The roller cutter of claim 19, further comprising:
an axle assembly for securing the disc spring relative to the hub,
said axle assembly including an axially extending axle and a nut disposed on the axle,
said axle extending axially through said disc spring,
said nut being axially shiftable along the axle so as to increase or decrease an axial compressive force on the disc spring.
